(19) United States
(12) Patent Application Publication
(10) Pub. No.: US 2013/0033958 A1
(43) Pub. Date: Feb. 7, 2013

(54) Machine for the treatment of food mixtures with centralized activation

(71) Applicant: Genesio Bravo, Sovizzo (VI) (IT)

(72) Inventor: Genesio Bravo, Sovizzo (VI) (IT)

(73) Assignee: G.S.G. S.R.L., Vicenza (IT)

(21) Appl. No.: 13/520,768

(22) PCT Filed: Apr. 12, 2011
(86) PCT No.: PCT/EP2011/001816

§ 371 Date: Jul. 5, 2012

(30) Foreign Application Priority Data
Apr. 26, 2010 (IT) MI2010A000707

(51) Int. Cl. B01F 7/16; B01F 7/30

(52) U.S. Cl. 366/272; 366/309

(57) ABSTRACT

A machine for the treatment of food mixtures with centralized activation includes a collection container or cylinder for a food mixture, in which a rotating shaft is positioned, wherein, on a sleeve at least partially integral with the rotating shaft, there is a shaped support for both a treatment tool and for scraping and mixing blades of the walls and bottom of the container or cylinder, the shaped support carrying transmissions for the rotation of both the treatment tool and the scraping and mixing blades and the shaped support.

### FIELD OF THE INVENTION

The present invention relates to a machine for the treatment of food mixtures with centralized activation.

### BACKGROUND OF THE INVENTION

In the field of the treatment of food mixtures, there are machines designed for the treatment of a wide variety of mixtures, such as for example those designed for the production of ice-cream, confectionery and gastronomic products.

In order to be able to do this, either various machines are used, each dedicated to a particular treatment operation of the specific food mixture, or different tools, each motorized, are gradually introduced into a single machine, which carry out a particular operation required by effecting the various interventions necessary.

In this latter case, for example, there must be the possibility of inserting, through an opening facing upwards, a particular motorized tool - into the basin of a machine suitable for treating food which must be subjected, in consecutive times, to various phases - which intervenes on the food product being treated in the same basin.

With this type of intervention, problems arise relating to the safety of the operator holding the tool and who must keep it in the correct position or, if the tool is fixed to the machine, the positioning must be such as to allow the coordination of the rotation between itself and, for example: scraping blades and bottom and side mixers, held and activated by the central shaft of the machine. It is in fact possible for undesired interferences to be caused between the parts in movement with reciprocal damage.

It is therefore evident that this operation can be quite difficult, if not dangerous, and is entrusted to the capacity and experience of the operator who is handling the machine and various tools.

### SUMMARY OF THE INVENTION

A general objective of the present invention is therefore to solve the drawbacks indicated above of the known art in an extremely simple, economical and particular functional way.

A further objective is to provide a treatment machine capable of exerting various functions which are concentrated in a single machine.

Another objective is to provide a treatment machine in which various tools can function contemporaneously without the possibility of interference with each other and with coordinated interventions.

In view of the above objectives, according to the present invention, a machine has been conceived for the treatment of food mixtures having the characteristics described hereinafter.

### BRIEF DESCRIPTION OF THE DRAWINGS

The structural and functional characteristics of the present invention and its advantages with respect to the known art will appear more evident from the following description, referring to the enclosed drawings, which, among other things, show an embodiment of a machine for the treatment of food mixtures produced according to the invention itself.

In the drawings:

FIG. 1 is a schematic perspective view from above of a machine for the treatment of food mixtures produced according to the invention with the processing group in a basin, exploded and without a protective lid;

FIG. 2 is a view completely similar to that of FIG. 1 with sectional parts and partially represented;

FIG. 3 is an enlarged sectional view of the processing group of the machine alone;

FIG. 4 is a sectional view of part of what is shown in FIG. 3 with an exploded tool which can substitute that assembled;

FIG. 5 is a view from above of part of the group shown in FIG. 4.

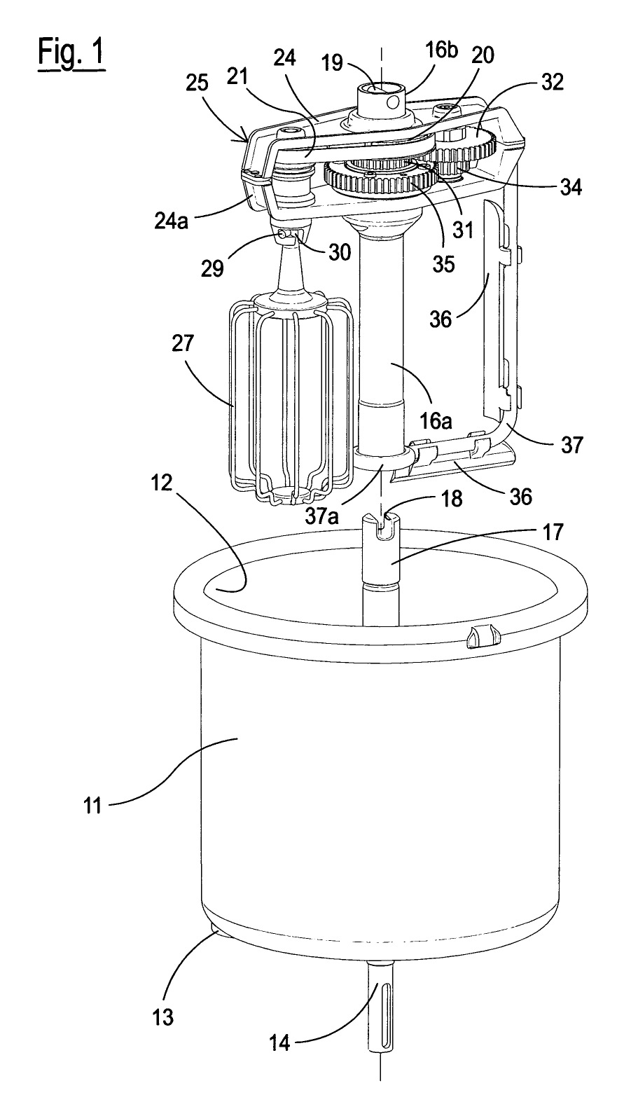

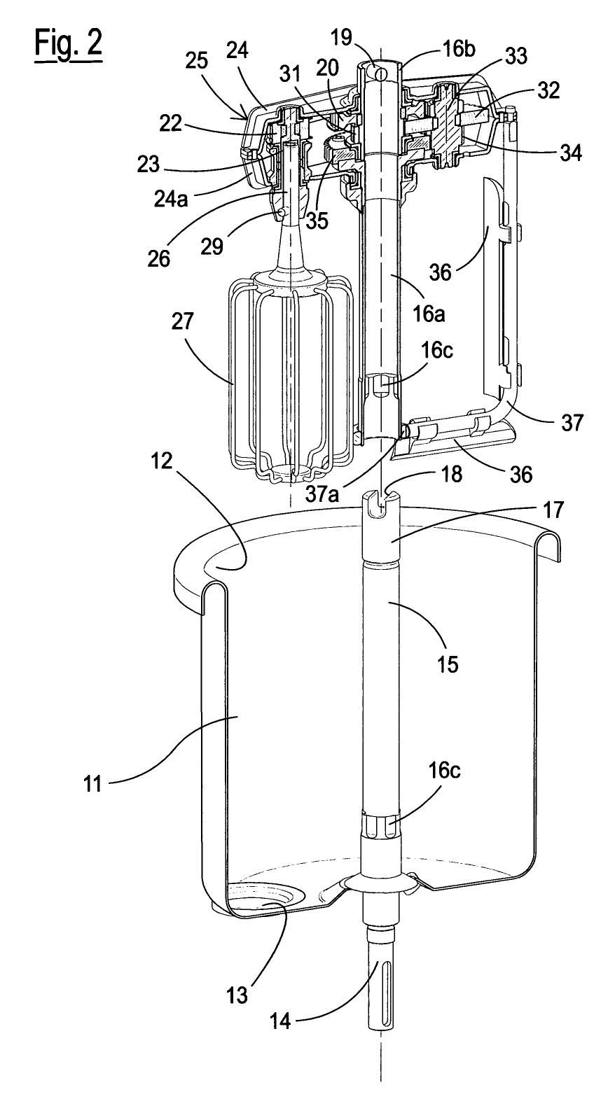

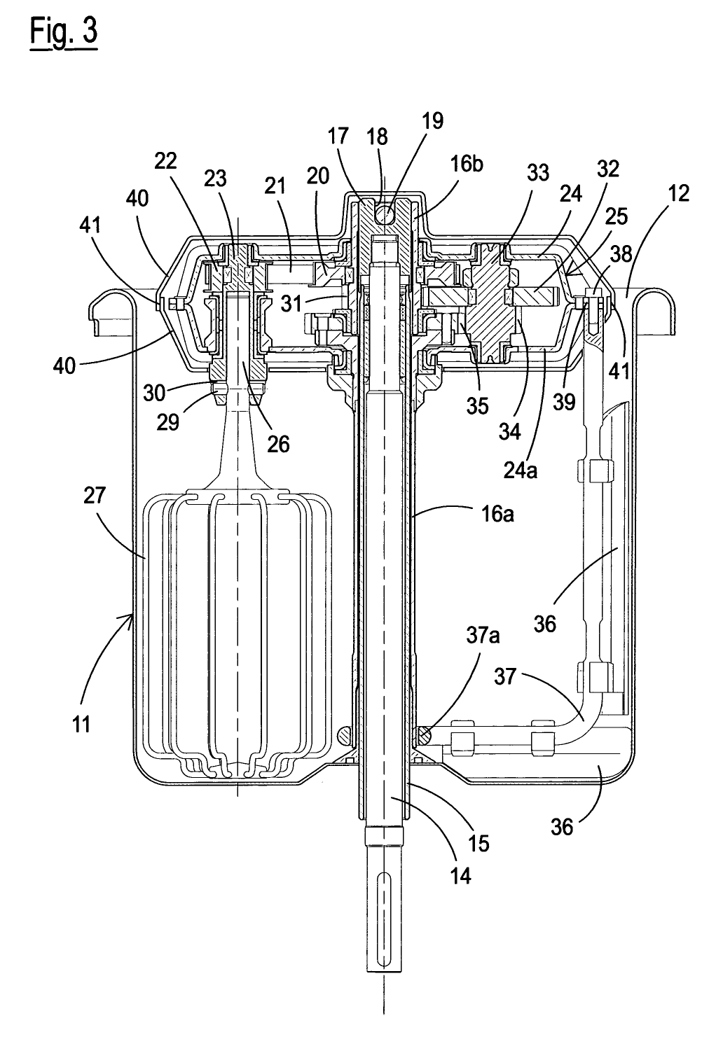

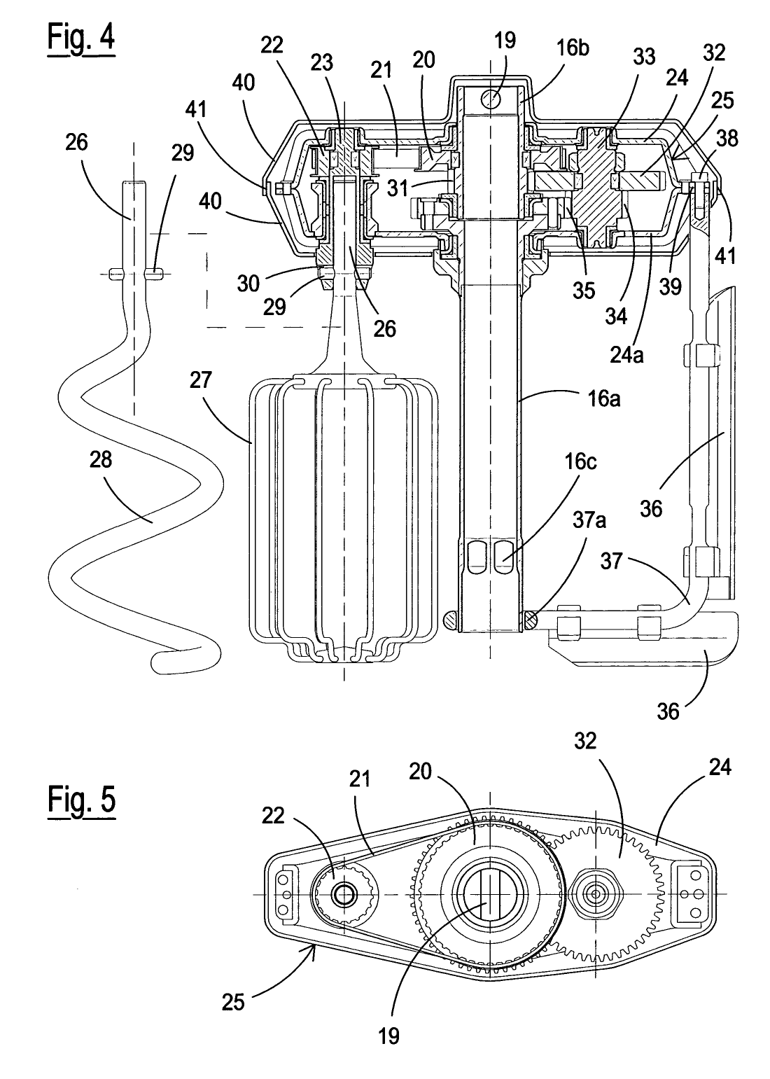

### DETAILED DESCRIPTION OF EMBODIMENTS OF THE INVENTION

With reference to the various figures, these illustrate a machine for the treatment of food mixtures, in particular for the production of ice-cream, confectionery and gastronomic products, provided according to the invention with a centralized activation.

The machine, shown in its characterizing parts, essentially comprises a steel container or cylinder 11 which acts as a basin for containing the food mixture to be treated, equipped with an opening 12 facing upwards for loading, in addition to a hole at the bottom 13 for discharging the mixture.

A rotating shaft 14, coaxial to the container 11, motorized from below by means of a motor reducer (not shown) is positioned in the container or cylinder 11. A pair of coaxial cylindrical sleeves 15 and 16a and 16b, is inserted on the rotating shaft 14. The first internal sleeve 15 serves for centering and blocking through sides 16c for a lower fixed portion 16a and an upper movable portion 16b of the second outer sleeve.

An upper end 17 of the rotating shaft 14 comprises a hollow diametrical seat 18 in which a pass-through pin 19 situated at an end of the upper portion 16b of the second outer sleeve, is engaged.

This creates a rotating engagement between the rotating shaft 14 and a driving pulley 20 integral with the upper portion 16b of the body of the second outer sleeve. The driving pulley 20 activates a controlled pulley 22, by means of a toothed belt 21. The controlled pulley 22 is constrained to a hollow shaft 23 supported for the rotation at its ends, in a shaped support 24, 24a which together form a transmission box 25, both rotating with respect to the two portions 16a and 16b of the second outer sleeve.

In a second embodiment (not shown in the figure) instead of the pulley 20, belt 21 and controlled pulley 22, a series of toothed wheel gears having the same function of transmitting movement to the hollow shaft 23.

In the invention, there are no metallic transmission chains, or movement transmission elements which require lubrication, this avoids the possible infiltration of oils or mineral fats on the food product treated.

A stem 26 of a treatment tool, such as a whisk 27, a mixing screw 28, etc., is inserted in the hollow shaft 23. More specifically, the treatment tool (27, 28, etc.) is constrained by means of a pin 29, integral with its stem 26, to a bayonet connection 30 situated at an end of the hollow shaft 23. This forms a wedge- insertion, wherein the wedge-insertion can be of the bayonet connection type (29, 30), as shown, or by means of screws or of another type.

This creates an independent rotation movement trans-mission to a treatment tool using the movement transmit-ted by the rotating shaft 14 positioned in the container or cylinder 11.

A toothed bush 31 is further integral with the upper portion 16b of the second outer sleeve, coaxial to the driving pulley 20. Said toothed bush 31 is engaged in a first gear 32, positioned integral with an intermediate shaft 33, supported for the rotation at its ends in the shaped support 24, 24a contained inside a transmission box 25.

The intermediate shaft 33 carries a second gear 34, integral and coaxial with the first gear 32. The second gear 34 is in turn engaged with a third gear 35, facing this and integral with a lower portion 16a of the second outer sleeve.

It should be pointed out that the transmission box 25 and shaped supports 24, 24a contained inside the box are free to rotate with respect to this lower portion 16a of the second sleeve.

Furthermore, it should be noted that a ring made of a metallic material 37a, which can rotate freely, is installed integral with the lower portion 16a of the second sleeve, to which an upright or “L”-shaped rod 37 is connected, joined to an end of the transmission box 25 where a pair of scraping and mixing blades 36 of the bottom and internal walls of the basin 11, is rotatingly supported.

In particular, these blades 36 are positioned on the rod 37, whose ends are constrained on one side to the above-mentioned ring 37a, disengaged from the lower portion 16a of the second sleeve, and on the other side, by means of a screw 38, to a ring 39 which extends from the shaped support 24 forming the transmission box 25. In this way, with the rotation of the transmission box 25 or shaped support 24 with respect to the rotating shaft 14, the blades 36 acting inside the container or cylinder 11, also rotate.

This thus controls the rotation of both the blades 36 and the shaped support carrying the treatment tool 27, 28.

With the arrangement according to the present invention, the rotation of the scraping and mixing blades is firstly effected, and also the self-rotation of a further treatment tool, such as the whisk 27, the mixing screw 28, or other types not shown in the drawings but which can obviously be housed inside the cylinder 11. The rotation of the additional tool is effected by the rotation of the driving pulley 20, the toothed belt 21 and the controlled pulley 22.

Furthermore, the presence of a set of gears which are always moved by the rotating shaft 14 of the basin, or container 11, also causes the rotation of the trans-mission box 25 which leads to the rotation of the treatment tool and scraping and mixing blades inside the basin.

In this way, with a single rotational movement, various movements of different groups with different functions are effected; the tool 27, moreover, thanks to the multiplicative or reductive relation produced by the combination of toothed wheels 20 and 22, rotates at a higher or lower rate with respect to the rate of the shaft 14.

A safety lid 40, which conceals, in its interior, the transmission box 25, and also all the toothed wheel gears and pulleys inside the box, must be made of a plastic or metallic material and must be absolutely compatible with the food. Furthermore, bearings and brasses, on which the gears rotate, must be able to resist high temperatures (caused by the friction of the rotation and heat released from the basin 11 when the latter is heated) without degenerating, but at the same time maintaining compatibility with the food.

The safety lid 40 must also guarantee an extremely simple dismantling, thanks to the help of wedge-insertions 41 or screws (not shown in the figure), in this way the transmission box 25 can be completely washed and sanitized also in dishwashers.

Depending on the food product to be treated and treatment to be obtained, the treatment tool 27 can be easily substituted in the same basin 11 with a simple bayonet connection 29.

This arrangement also facilitates cleaning operations and at the same time allows an easy substitution of the single tool.

It is therefore advantageously possible to operate with various forms of treatment without having to move the food mixture to be treated from one container to another.

The objective indicated in the preamble of the description has therefore been achieved.

The forms of the structure for the production of a machine for the treatment of food mixtures of the invention, as also the materials (provided they are compatible with food and are washable) and assembly procedures, can naturally differ from those shown for purely illustrative and non-limiting purposes in the drawings.

The protection scope of the invention is therefore delimited by the enclosed claims.

The invention claimed is:

1. A machine for treatment of food mixtures with centralized activation comprising:
a collection container or cylinder for a food mixture;
a rotating shaft positioned in said collection container or cylinder;
a shaped support for both a treatment tool and for scraping and mixing blades of walls and bottom of the collection container or cylinder, said shaped support being provided on a sleeve at least partially fixedly coupled with said rotating shaft; and
transmissions carried by said shaped support, said transmissions being made of a material not requiring lubrication with oil or mineral fats, said transmissions providing for rotation with multiplication or reduction of a revolution number of said treatment tool and for integral rotation with the shaped support, containing a transmission box therein, and with said scraping and mixing blades.

2. The machine according to claim 1 wheerin said transmission for the rotation of said treatment tool comprises a driving pulley, fixedly coupled to an upper portion of the sleeve, which, by a toothed belt, activates a controlled pulley constrained to a hollow shaft, supported for rotation at ends thereof in said shaped support, and said hollow shaft supporting said treatment tool.

3. The machine according to claim 2, wherein said transmission for the rotation of said treatment tool comprises a planetary of toothed gears which activate the controlled pulley.

4. The machine according to claim 2, wherein said hollow shaft is configured to receive a stem of said treatment tool by a wedge-insertion.

5. The machine according to claim 1, wherein one of the transmissions is for the rotation of said scraping and mixing blades and of the shaped support, comprises a series of gears, and is fixedly coupled to an upper portion of said sleeve.

6. The machine according to claim 5, wherein said series of gears rotate on bushes made of a material which does not require lubrication with oils or mineral fats.

7. The machine according to claim 5, wherein said series of gears comprises a toothed socket, which is integral with said upper portion of said sleeve and is engaged in a first gear, fixedly coupled to an intermediate shaft, supported for the rotation at ends thereof in the shaped support and carrying, fixed and coaxial with the first gear, a second gear which in turn is engaged with a third gear, facing the second gear and fixedly coupled to a lower portion of the sleeve, said scraping and mixing blades and said shaped support being fixedly coupled to said lower portion of the sleeve.

8. The machine according to claim 1, wherein said sleeve is arranged so as to rotate externally above a further sleeve also rotating with respect to said rotating shaft.

9. The machine according to claim 1, wherein said treatment tool is a whisk or a mixing screw (28) or another tool suitable for the treatment of a liquid, solid or pasty food mixture.

10. The machine according to claim 4, wherein said wedge-insertion is a bayonet connection or is achieved with screws.
